(19) United States
(12) Patent Application Publication
(10) Pub. No.: US 2016/0063202 A1
(43) Pub. Date: Mar. 3, 2016

(54) SYSTEMS AND METHODS TO CLASSIFY AND RANK HEALTH INFORMATION

(71) Applicant: BIOXCEL CORPORATION, Branford, CT (US)

(72) Inventor: Krishnan NANDABALAN, Guilford, CT (US)

(21) Appl. No.: 14/784,852

(22) PCT Filed: Apr. 30, 2014
(86) PCT No.: PCT/US14/36276

§ 371 Date: Oct. 15, 2015

Related U.S. Application Data
(60) Provisional application No. 61/817,371, filed on Apr. 30, 2013.

(51) Int. Cl. G06F 19/00; G06F 17/30

(52) U.S. Cl. CPC G06F 19/345; G06F 17/30345; G06F 17/30598; G06F 17/30876; G06F 19/322; G06F 19/3481

(57) ABSTRACT

A systems and methods to classify and rank health information assists individuals with personalized and specific health choices by guiding them to the relevant stages in any health area comprising healthy living, disease diagnosis, treatment and cure, or management of disease. The system will personalize the health journey for each consumer based on user inputs by classifying user inputs into specific personal health types, wherein each personal health type is classified and weighted into a knowledgebase, based on a frame-work. The personalized health journey will be inclusive of all the associated details about healthy living, diagnosis, treatments, long term management of disease, and leading developments in the disease area.

### RELATED APPLICATION

The present application claims the benefit of U.S. Provisional Patent Application No. 61/817,371, filed on Apr. 30, 2013, which is hereby incorporated by reference in its entirety.

### FIELD

The present invention relates to the field of managing health. More particularly, and without limitations, the systems and methods to classify and rank health information provide a personal health type and personal health recommendations corresponding to the personal health data that has been collected.

### BACKGROUND

Health management demands the need for constant monitoring of physical conditions and diagnosis of diseases. Timely monitoring requires access to reliable, relevant, and up-to-date information, and this information is often obtained by using available search engines such as Google or Bing. However, since such search engines provide a plethora of indiscriminate health-related information, it becomes very difficult for patients to comprehensively and accurately understand the health-related information. It is important to understand the health-related information available and take health decisions, but data obtained from numerous sources may prove unsatisfactory as they provide generic information. Such information may tend to mislead users that may lead to manifestation of serious health problems which may further result in additional complications to a user.

Thus, it is important to organize and characterize information available on internet such that a patient may understand and take health decisions.

Many healthcare related websites such as WebMD or EverydayHealth provide blanket information about any health-related subject without discriminating as to what is the level of information being provided to the consumer. There are also websites such as Sermo that are physician oriented and one has to be a registered physician with the AMA to register oneself to use it, or other sites like PatientsLikeMe are exclusively for patients already diagnosed with a disease and mainly deals with the response to medications and compliance.

However, such websites have an escalating level of information and knowledge being made available to any consumer without assessing the specific needs of the consumer and often leave consumers of this information confused and upset about their health conditions and at worst indecisive about the choices of actions confronting them regarding their health condition. Finally, none of the resources mentioned above create a lasting resource for the consumer to refer back on a need-basis or provide a social network of like-minded consumers.

None of the above technologies address user inputs or queries while considering the demographic, historical, or geographical details of the users, gender orientations, disabilities, previous and pipelined treatments etc. to provide the specific user oriented result because such differentiating characteristics drastically influence medical treatment models. Additionally, the frameworks disclosed in all the above technologies don't necessarily rank every user input into separate user-types based on the pre-selected parameters.

In addition to accuracy, healthcare information needs to be prioritized for a user such that the user can make the necessary health-related decisions in consultation with their physician. Further, many of the existing technologies don't provide a social, interactive forum to serve as an assembly platform for patients, healthcare professionals, doctors, suppliers, pharmacists, etc.

Hence, in light of the discussion above, it is desirable to devise a standardized healthcare decision making platform for consumers that overcomes one or more problems and disadvantages of the prior art.

### SUMMARY

A method for managing health comprising obtaining, by a health management computing device, personal health profile data comprising one or more personal health parameters wherein each of the one or more personal health parameters comprises one of a plurality of values for each of the personal health parameters. Next, a deviation is determined, by the health management computing device, from one or more of the one of the plurality of values for one or more of the personal health parameters from a subset range of the plurality of values for the one or more of the personal health parameters. A weighting factor is determined, by the health management computing device, for the one or more of the plurality of values for the one or more of the personal health parameters based on the determined deviation relative to the determined deviation of the other one or more of the plurality of values. The one or more of the personal health parameters along with the corresponding determined weighting factor for the one or more of the personal health parameters are correlated, by the health management computing device, with one of a plurality of personal health types, wherein each of the plurality of personal health types is associated with one or more health data points. The correlated personal health type and the one or more health data points are provided by the health management computing device.

A health management computing device comprising one or more processors and a memory, wherein the memory coupled to the one or more processors is configured to execute programmed instructions stored in the memory comprising obtaining personal health profile data comprising one or more personal health parameters, wherein each of the one or more personal health parameters comprises one of a plurality of values for each of the personal health parameters. A deviation is determined of one or more of the one of the plurality of values for one or more of the personal health parameters is from a subset range of the plurality of values for the one or more of the personal health parameters. A weighting factor is determined for the one or more of the plurality of values for the one or more of the personal health parameters based on the determined deviation relative to the determined deviation of the other one or more of the plurality of values. The one or more of the personal health parameters along with the corresponding determined weighting factor for the one or more of the personal health parameters are correlated with one of a plurality of personal health types, wherein each of the plurality of personal health types is associated with one or more health data points. The correlated personal health type and the one or more health data points are provided.

A non-transitory computer-readable medium having stored thereon instructions for health management in a health management system comprising machine executable code which when executed by at least one processor, causes the processor to perform steps comprising obtaining personal health profile data comprising one or more personal health parameters, wherein each of the one or more personal health parameters comprises one of a plurality of values for each of the personal health parameters. A deviation is determined of one or more of the one of the plurality of values for one or more of the personal health parameters is from a subset range of the plurality of values for the one or more of the personal health parameters. A weighting factor is determined for the one or more of the plurality of values for the one or more of the personal health parameters based on the determined deviation relative to the determined deviation of the other one or more of the plurality of values. The one or more of the personal health parameters along with the corresponding determined weighting factor for the one or more of the personal health parameters are correlated with one of a plurality of personal health types, wherein each of the plurality of personal health types is associated with one or more health data points. The correlated personal health type and the one or more health data points are provided.

This technology provides a number of advantages including providing more effective methods, devices, and non-transitory computer readable media for providing a personal health type and personal health recommendations.

By way of example only, when an individual uses connects to the technology through a mobile device, the individual is presented with a series of questions regarding their particular health characteristics. Accordingly, the individual is provided with a personalized health type corresponding to their particular set of answers to the questions presented. This personalized health type benefits the individual by providing an easy to understand summary of their health issues. Additionally, in one embodiment, the technology provides an individual with a set of personal health recommendations corresponding to the personal health type. These personal health recommendations provide the user with recommendations of courses of actions that the user may take to benefit their health. These recommendations include dietary and general lifestyle recommendations such as recommendations to eat or avoid eating certain foods, or to participate in various exercise activities. Additionally, the technology accesses a knowledgebase comprising data points. The technology benefits the user by providing the user with disease information, one or more medical treatments, and one or more pharmaceuticals associated with the individuals correlated personal health type.

### BRIEF DESCRIPTION OF THE DRAWINGS

The features of the present invention, which are believed to be novel, are set forth with particularity in the appended claims. The invention may best be understood by reference to the following description, taken in conjunction with the accompanying figures. These figures and the associated description are provided to illustrate some embodiments of the invention, and not to limit the scope of the invention.

FIG. 1 is an exemplary network environment comprising a health management computing device for providing personal health types and health data points;

FIG. 2 is an exemplary functional block diagram of the health management computing device;

FIG. 3 is an exemplary functional block diagram of the modules within a memory of the health management computing device;

FIG. 4 is an exemplary flow chart for providing personal health types and health data points;

FIG. 5 is an exemplary flow chart for determining a deviation for a personal health parameter value; and

FIG. 6 is an exemplary health parameter table.

### DETAILED DESCRIPTION OF THE INVENTION

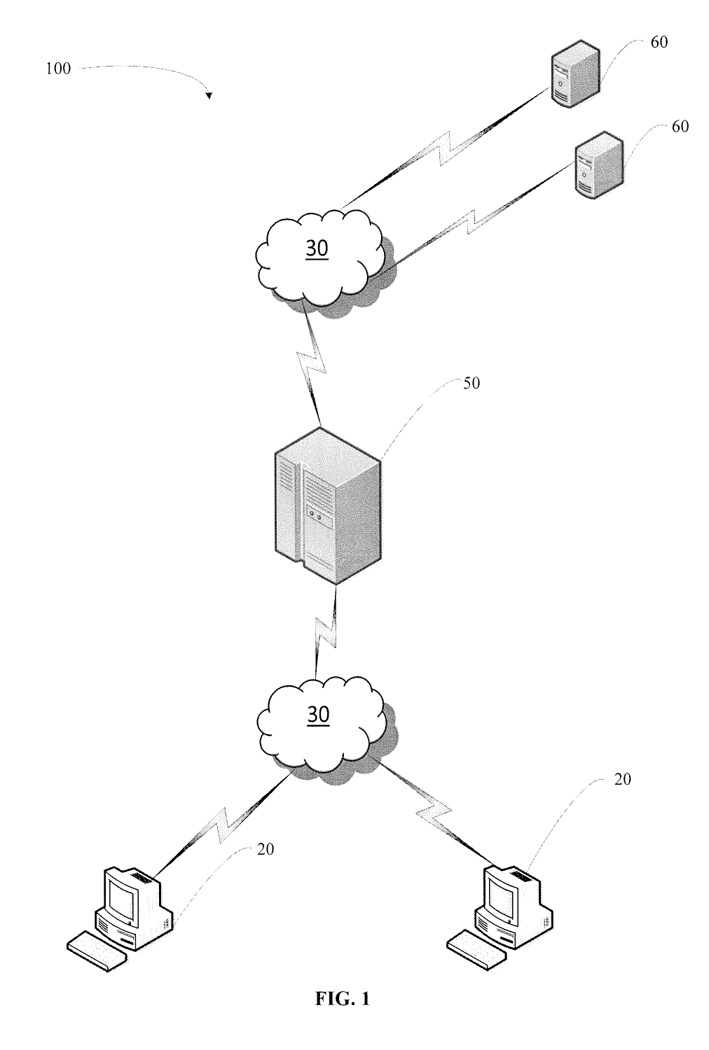

An exemplary network environment 100 with a health management computing device 50 for providing a personal health type is as illustrated in FIG. 1. The exemplary network environment 100 includes a plurality of computing devices 20(a)-10(b), the health management computing device 50, and a plurality of servers 60, which are coupled together by the communication networks 30, although the environment can include other types and numbers of devices, components, elements and communication networks in a variety of other topologies and deployments. While not shown, the exemplary environment 100 may include additional components, such as routers, switches and other devices which are well known to those of ordinary skill in the art and thus will not be described here. This technology provides a number of advantages including providing more effective methods, non-transitory computer readable medium and devices for predicting customer satisfaction.

Referring more specifically to FIG. 1, health management computing device 50 interacts with the plurality of computing devices 20(a)-20(b), knowledge database 60, and the plurality of servers 60 through the communications network 30, although the health management computing device 50 can interact with the computing devices 20(a)-20(b), and the plurality of servers 60 using other methods and techniques. Communication networks 30 include local area networks (LAN), wide area network (WAN), 3G technologies, GPRS or EDGE technologies, although the communication networks 30 can include other types and numbers of networks and other network topologies.

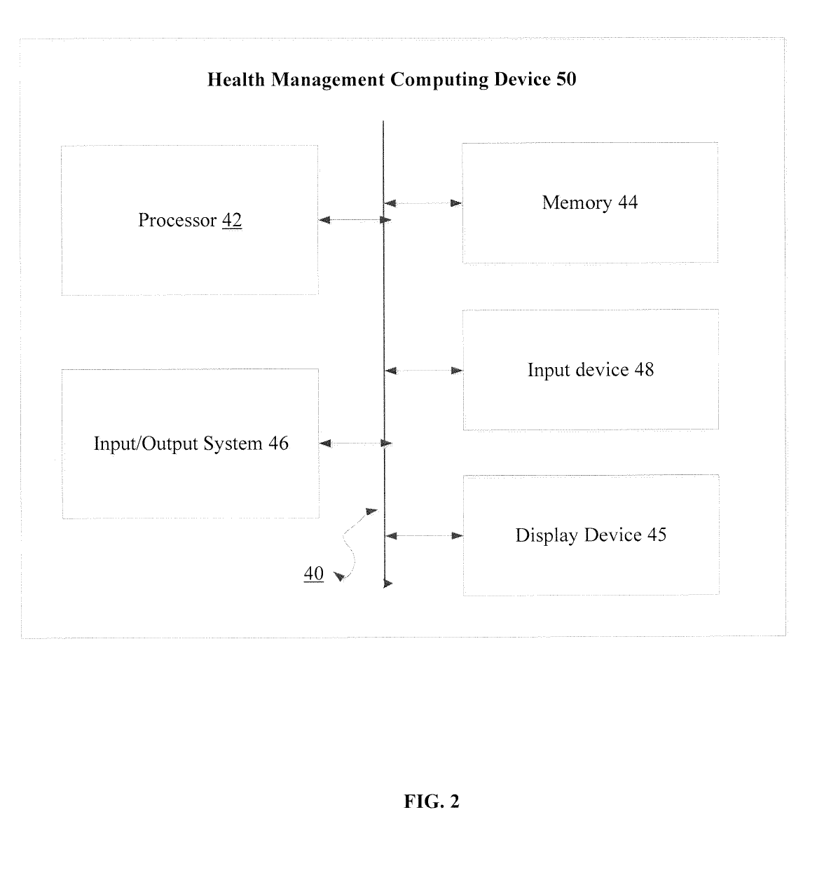

The health management computing device 50 provides personal health types and health data points within a network environment 100 as illustrated and described with the examples herein, although health management computing device 50 may perform other types and numbers of functions and in other types of networks. As illustrated in FIG. 2, health management computing device 50 includes at least one processor 42, memory 44, input device 48 and display device 45, and input/output (I/O) system 46 which are coupled together by bus 40, although utility management computing device 14 may comprise other types and numbers of elements in other configurations.

Processor(s) 42 may execute one or more computer-executable instructions stored in the memory 44 for the methods illustrated and described with reference to the examples herein, although the processor(s) can execute other types and numbers of instructions and perform other types and numbers of operations. The processor(s) 42 may comprise one or more central processing units (“CPUs”) or general purpose processors with one or more processing cores, such as AMD® processor(s), although other types of processor(s) could be used (e.g., Intel®).

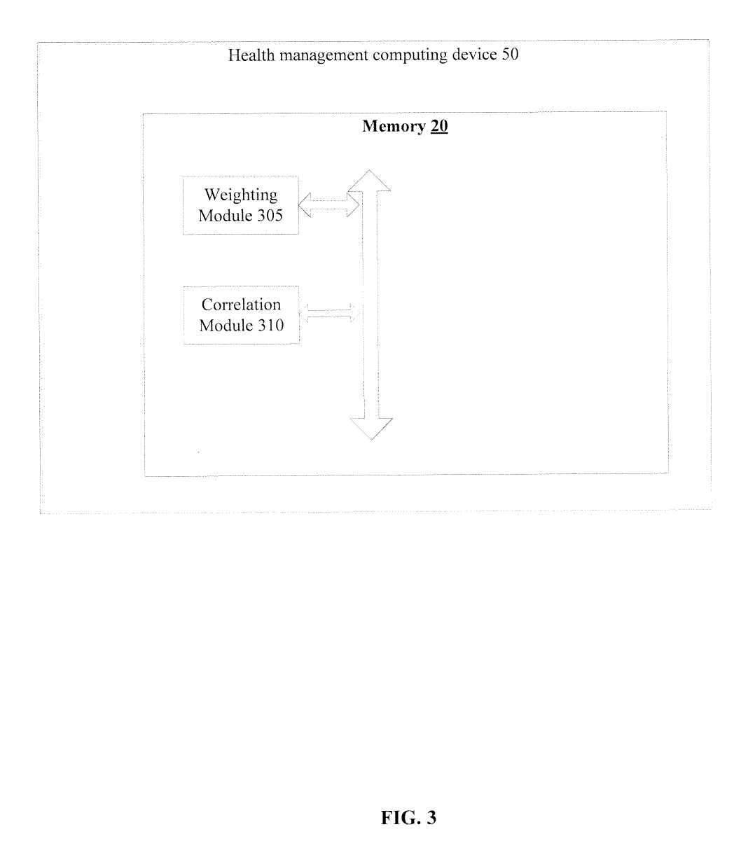

Memory 44 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 44 may store one or more programmed instructions of this technology as illustrated and described with reference to the examples herein that may be executed by the one or more processor(s) 18. By way of example only, the flow charts shown in FIG. 3, is representative of programmed steps or actions of this technology that may be embodied or expressed as one or more non-transitory computer or machine readable having stored instructions stored in memory 44 that may be executed by the processor(s) 42, although other types and numbers of programmed instructions and/or other data may be stored.

Additionally as illustrated in FIG. 3, the memory 44 includes a weighting module 305, and a correlation module 310 to assist the health management computing device 50 with providing a personal health type and health recommendations, although memory 44 can include other types and numbers of modules. In this example, the weighting module 305 includes a set of methods to calculate the a weighted parameter value for individual health parameters, although the weighting module 305 can accept other types or amounts of information. The correlation module 310 includes a set of methods to correlate personal health data with a personal health type, and to provide data points associated with the respective personal health type. These applications can be accessed from web portals and/or mobile devices as per requirements.

Input device 48 enables a user, such as a patient, to interact with the health management computing device 50, such as to input and/or view data and/or to configure, program and/or operate it by way of example only. By way of example only, input device 48 may include one or more of a touch screen, keyboard and/or a computer mouse.

The display device 45 enables a user, such as a patient, to interact with the health management computing device 50, such as to view and/or input information and/or to configure, program and/or operate it by way of example only. By way of example only, the display device 45 may include one or more of a CRT, LED monitor, LCD monitor, or touch screen display technology although other types and numbers of display devices could be used.

The Input/output system 46 in the health management computing device 50 is used to operatively couple and communicate between the health management computing device 50, the computing devices 20, the plurality of servers 60 which are all coupled together by communication network 30. In this example, the bus 42 is a hyper-transport bus in this example, although other bus types and links may be used, such as PCI.

Each of the plurality of computing devices 20 includes a central processing unit (CPU) or processor, a memory, an interface device, and an I/O system, which are coupled together by a bus or other link, although other numbers and types of network devices could be used. The plurality of computing devices 20 communicate with the health management computing device 50 for providing a personal health type and one or more health data points through the health management computing device 50, although the computing devices 20 can interact with the health management computing device 50 by other techniques. The plurality of computing devices 20 may run interface application(s), such as a Web browser, that may provide an interface to make requests for and receive content and/or communicate with web applications stored on the plurality of servers 60 16(1)-16(n) via the communication network 30.

The network environment 10 also includes the plurality of servers 60. Each of the plurality of servers 60 includes a central processing unit (CPU) or processor, a memory, an interface device, and an I/O system, which are coupled together by a bus or other link, although other numbers and types of network devices could be used. The plurality of servers 60 communicate with the health management computing device 50 through communication network 30, although the plurality of servers 60 can interact with the health management computing device 50 by other techniques. Various network processing applications, such as CIFS applications, NFS applications, HTTP Web Server applications, and/or FTP applications, may be operating on the plurality of servers 60 and transmitting content (e.g., files, Web pages) to the plurality of computing devices 20 or the health management computing device 50 in response to requests.

Although an exemplary telecommunications network environment 10 with the plurality of computing devices 20, health management computing device 50 and plurality of servers 60 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

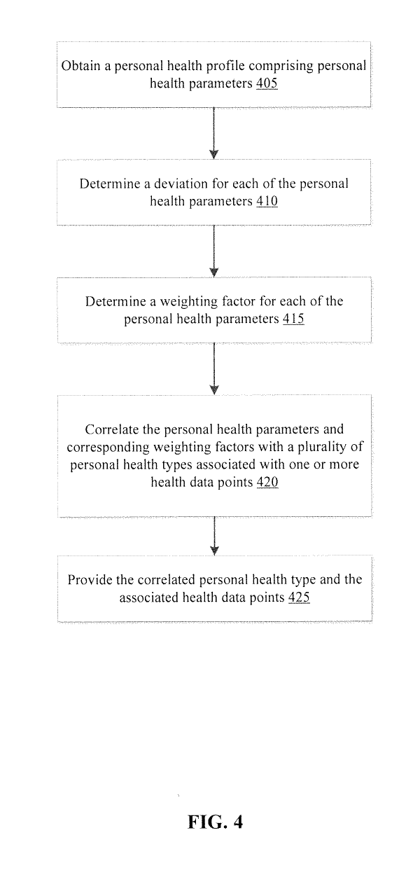

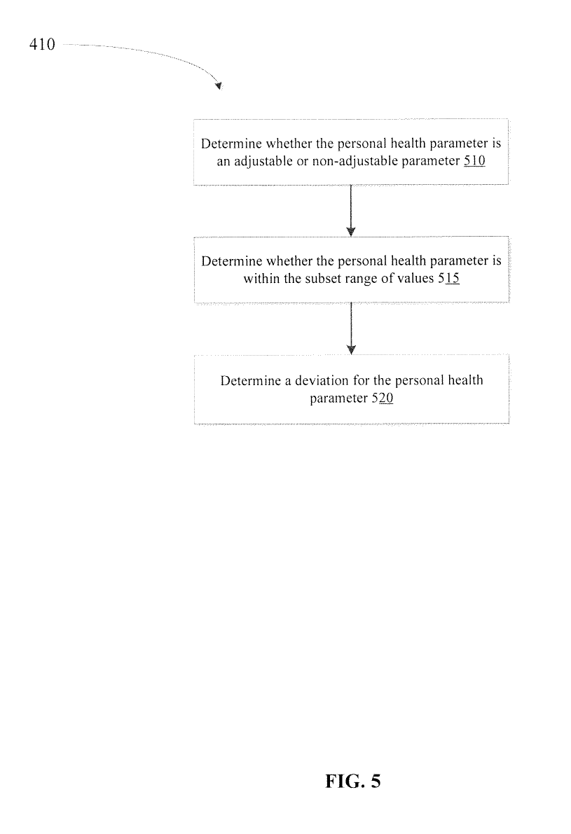

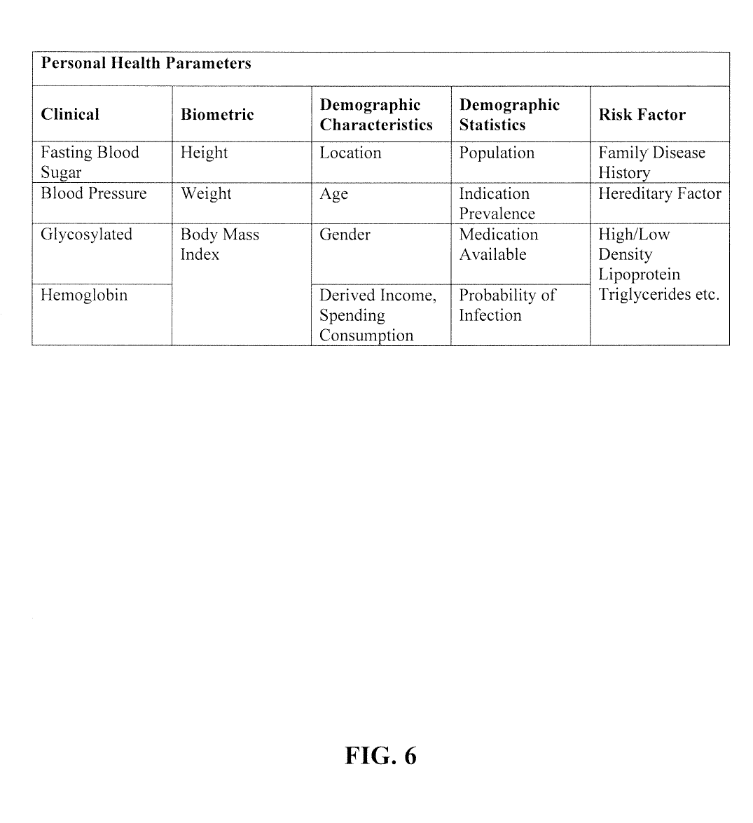

An exemplary method for providing a health user type 130 and health data points 132 will now be described with reference to FIGS. 4-6. Particularly with reference to FIG. 4, in step 405, the health management computing device 50 obtains personal health profile data 102 from one of the plurality of computing devices 20 associated with the health management computing device 50, wherein the personal health profile data 102 comprises one or more personal health parameters 104. By way of example only, the personal health parameters 104 comprises Body Mass Index (“BMI”), gender, and blood pressure. FIG. 6 illustrates examples of personal health parameters 104. In some embodiments of the invention the personal health profile data 102 is stored.

In step 410, the health management computing device 50 determines a deviation 110 from a subset range of values 112 for the personal health parameters 104. In this example, determining the deviation 110 from a subset range of values 112 relates to taking the value of the personal health parameter 104 and comparing it to the subset range of values 112 for that particular parameter 104. The deviation 110 from the subset range of values 112 is the extent to which the value of the personal health parameter 104 is greater or less than a pre-determined range of values 112. By way of example only, in some embodiments of the invention, the deviation 110 from the subset range of values is variously expressed as a percentile, a ranking, or a standard deviation.

In step 415, the health management computing device 50 determines a weighting factor 120 for each of the values 106 for the one or more personal health parameters 104. In this example, each of the weighting factors 120 is determined by dividing each of the individual deviations 110 from the subset of ranges 112 by the summation of the deviations 110 from the three personal health parameters 104.

In step 420, the health management computing device 50 correlates the personal health parameters 104 with the corresponding weighting factor to one of a plurality of personal health types 130. The health management computing device 50 is configured to send data to and receive data from the plurality of servers 60. In this example, the health management computing device 50 sends the weighting factors corresponding to the personal health parameters to one of the plurality of servers 60. Plurality of servers 60 maintains a plurality of personal health types wherein each of the plurality of personal health types 130 comprises one or more weighting factor types 122. The health management computing device 50 first correlates the set of personal health parameters 104 and corresponding weighting factors 120 with a personal health type 130 that has a corresponding set of weighting factor types 122. Next, the health management computing device 50 compares the values of the weighting factor types 122 with the respective values of the weighting factors 120.

The health management computing device 50 correlates the personal health type 130 and its corresponding weighting factor types 122 with the personal health parameters 104 and corresponding weighting factors with the values that are most similar. Each of the personal health types 130 is associated with one or more health data points. The health data points 132 comprise information about diseases, one or more medical treatments, or one or more pharmaceuticals.

In step 425, the health management computing device 50 provides the correlated health type 130 and the one or more health data points. Additionally, in other embodiments of the invention, the one or more health data points 132 comprise health recommendations including exercise plans, and diet plans. In other embodiments of the invention the health management computing device 50 further correlates the personal health type 130 with one or more Internet links to one or more health references from one of the plurality of servers 60.

In step 510, the health management computing device 50 determines whether the personal health parameter is adjustable or non-adjustable. Certain personal health parameters 104 like gender are deemed to be non-adjustable due to not having a range of values 112 and hence are not weighted. In some embodiments of the invention, the non-adjustable personal health parameters 128 are considered when correlating the personal health parameters 104 with the personal health types 130.

In step 515, the health management computing device 50 determines whether the personal health parameter 104 is within the subset range of values 112. In some embodiments of the invention, the subset range of values are in a linear distribution, however other ranges of values may be distributed in other ways.

In step 520, the health management computing device 50 determines a deviation 110 for the personal health parameter value 106. The deviation 110 is based on the degree to which the personal health parameter value 106 is different from the subset range of values 112. The deviation 110 may be expressed in a different number of forms comprising standard deviation or percentile ranking.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing health, the method comprising:
obtaining, by a health management device, personal health profile data comprising one or more personal health parameters, wherein each of the one or more personal health parameters comprises one of a plurality of values for each of the personal health parameters;
determining, by the health management computing device, a deviation of one or more of the one of the plurality of values for one or more of the personal health parameters from a subset range of the plurality of values for the one or more of the personal health parameters;
determining, by the health management computing device, a weighting factor for the one or more of the plurality of values for the one or more of the personal health parameters based on the determined deviation relative to the determined deviation of the other one or more of the plurality of values;
correlating, by the health management computing device, the one or more of the personal health parameters along with the corresponding determined weighting factor for the one or more of the personal health parameters with one of a plurality of personal health types, wherein each of the plurality of personal health types is associated with one or more health data points; and
providing, by the health management computing device, the correlated personal health type and the one or more health data points.

2. The method of claim 1, wherein the one or more personal health parameters further comprise one or more adjustable personal health parameters and one or more non-adjustable personal health parameters.

3. The method of claim 2 wherein the determined deviation and the determined weighting factor is for the one of the plurality of values for the one or more adjustable personal health parameters and wherein the correlating is further based on the one or more of the adjustable personal health parameters along with the corresponding determined weighting factor for the one or more of the adjustable personal health parameters and the one or more of the non-adjustable personal health parameters with the one of the plurality of personal health types.

4. The method of claim 1 further comprising:
identifying, by the health management computing device, one or more personal health recommendations that correspond with the correlated personal health type; and
providing, by the health management computing device, the identified one or more personal health recommendations.

5. The method of claim 1, further comprising:
correlating, by the health management computing device, the correlated personal health type with one or more corresponding Internet links to one or more health references; and
providing, by the health management computing device, the Internet links.

6. The method of claim 1, wherein the health data points comprise disease information, one or more medical treatments, or one or more pharmaceuticals.

7. The method of claim 1, wherein the one or more personal health parameters comprise clinical information, biometric information, demographic characteristics, demographic statistics, or risk factors.

8. A health management computing device comprising:
one or more processors;
a memory, wherein the memory coupled to the one or more processors is configured to execute programmed instructions stored in the memory comprising:
obtaining personal health profile data comprising one or more personal health parameters, wherein each of the one or more personal health parameters comprises one of a plurality of values for each of the personal health parameters;
determining a deviation of one or more of the one of the plurality of values for one or more of the personal health parameters from a subset range of the plurality of values for the one or more of the personal health parameters;
determining a weighting factor for the one or more of the plurality of values for the one or more of the personal health parameters based on the determined deviation relative to the determined deviation of the other one or more of the plurality of values;
correlating the one or more of the personal health parameters along with the corresponding determined weighting factor for the one or more of the personal health parameters with one of a plurality of personal health types, wherein each of the plurality of personal health types is associated with one or more health data points; and
providing the correlated personal health type and the one or more health data points.

9. The device of claim 8, wherein the one or more personal health parameters further comprise one or more adjustable personal health parameters and one or more non-adjustable personal health parameters.

10. The device of claim 9, wherein the determined deviation and the determined weighting factor is for the one of the plurality of values for the one or more adjustable personal health parameters and wherein the correlating is further based on the one or more of the adjustable personal health parameters along with the corresponding determined weighting factor for the one or more of the adjustable personal health parameters and the one or more of the non-adjustable personal health parameters with the one of the plurality of personal health types.

11. The device of claim 8, wherein the one or more processors are configured to execute programmed instructions stored in memory further comprising:
identifying one or more personal health recommendations that correspond with the correlated personal health type; and
providing the identified one or more personal health recommendations.

12. The device of claim 8, wherein the one or more processors are configured to execute programmed instructions stored in memory further comprising:
correlating the correlated personal health type with one or more corresponding Internet links to one or more health references; and
providing the Internet links.

13. The device of claim 8, wherein the health data points comprise disease information, one or more medical treatments, or one or more pharmaceuticals.

14. The device of claim 8, wherein the one or more personal health parameters comprise clinical information, biometric information, demographic characteristics, demographic statistics, or risk factors.

15. A non-transitory computer-readable medium having stored thereon instructions for health management in a health management system comprising machine executable code which when executed by at least one processor, causes the processor to perform steps comprising:
obtaining personal health profile data comprising one or more personal health parameters, wherein each of the one or more personal health parameters comprises one of a plurality of values for each of the personal health parameters;
determining a deviation of one or more of the one of the plurality of values for one or more of the personal health parameters from a subset range of the plurality of values for the one or more of the personal health parameters;
determining a weighting factor for the one or more of the plurality of values for the one or more of the personal health parameters based on the determined deviation relative to the determined deviation of the other one or more of the plurality of values;
correlating the one or more of the personal health parameters along with the corresponding determined weighting factor for the one or more of the personal health parameters with one of a plurality of personal health types, wherein each of the plurality of personal health types is associated with one or more health data points; and
providing the correlated personal health type and the one or more health data points.

16. The medium of claim 15, wherein the one or more personal health parameters further comprise one or more adjustable personal health parameters and one or more non-adjustable personal health parameters.

17. The medium of claim 16, wherein the determined deviation and the determined weighting factor is for the one of the plurality of values for the one or more adjustable personal health parameters and wherein the correlating is further based on the one or more of the adjustable personal health parameters along with the corresponding determined weighting factor for the one or more of the adjustable personal health parameters and the one or more of the non-adjustable personal health parameters with the one of the plurality of personal health types.

18. The medium of claim 15, wherein the instructions further comprise:
identifying one or more personal health recommendations that correspond with the correlated personal health type; and
providing the identified one or more personal health recommendations.

19. The medium of claim 15 wherein the instructions further comprise:
correlating the correlated personal health type with one or more corresponding Internet links to one or more health references; and
providing the Internet links.

20. The medium of claim 15, wherein the health data points comprise disease information, one or more medical treatments, or one or more pharmaceuticals.
